(19) United States
(12) Patent Application Publication
(10) Pub. No.: US 2013/0222171 A1
(43) Pub. Date: Aug. 29, 2013

(54) RADIO-FREQUENCY (RF) PRECISION NULLING DEVICE

(71) Applicant: BOOZ, ALLEN & HAMILTON, (US)

(72) Inventors: Michael Wilson MILES, Dayton, OH (US); Mark Lea AXTELL, Springfield, OH (US); Keith David SAWMILLER, Beavercreek, OH (US)

(73) Assignee: BOOZ, ALLEN & HAMILTON, McLean, VA (US)

(21) Appl. No.: 13/739,945

(22) Filed: Jan. 11, 2013

Related U.S. Application Data
(60) Provisional application No. 61/586,011, filed on Jan. 12, 2012.

(51) Int. Cl. H01Q 17/00

(52) U.S. Cl. CPC H01Q 17/008
USPC 342/4

(57) ABSTRACT

An exemplary interference nulling system includes an electromagnetic energy (e.g., RF) based system such as a radar system for transmitting radar signals and receiving return signals reflected from a target, and a nulling device having a surface for diffracting/blocking the transmitted signals to electromagnetically obscure the target. The nulling device is preferably sited between the transmitter and the target in a blanking range of the radar system.

### FIELD

The disclosure relates to a radar systems, such as a device for generating a three dimensional null region between an electromagnetic source and a target.

### BACKGROUND

The rapidly expanding development of wind-based energy across the world (most notably in the U.S. and Europe) has resulted in the deployment of thousands of radar-reflecting wind-turbines that interfere with Air Defense, Air Traffic Control (ATC), and Doppler Weather radars, and other airborne or ground based systems. The proliferation of wind turbines has created large volumes of airspace where radar coverage is negatively impacted, with potentially severe impact to homeland defense, storm alert/prediction capability, and flight tracking systems.

In the U.S., efforts are underway to allow for the development of more wind farms while also reducing or eliminating the adverse effects wind turbines can have on radar coverage, in areas such as homeland defense storms alert/prediction capability, and flight tracking systems. For example, one proposed solution manages the development requests from windfarm developers to assess, and mitigate if required, windfarm developments. Moreover, impact studies are prepared by the U.S. government, research organizations, and educational institutions in an effort to determine solutions for mitigating the effects of wind farms.

Known wind-turbine interference mitigation efforts to date are processor-based solutions focusing primarily upon developing hardware and software modifications, which employ advanced digital signal processing techniques to compensate for radar interference produced by the wind-turbines.

### SUMMARY

An exemplary interference nulling system is disclosed, comprising: a EM based (e.g., radar) system for transmitting EM signals and receiving return signals reflected from a target; and a nulling device having a surface for diffracting/blocking the transmitted radar signals to electromagnetically obscure the target, wherein the nulling device is sited between the EM transmitter system and the target, e.g., in a blanking range of a radar system, and the nulling device per se. In this way, the 2-way energy path between a radar system and a wind turbine, for instance, can be effectively blocked, by creating a 3-D dead zone.

### BRIEF DESCRIPTION OF THE DRAWING FIGURES

The exemplary embodiments of the disclosed systems and methods can be better understood with reference to the following drawings and description. The components in the figures are not necessarily to scale, emphasis instead being placed upon illustrating the principles of exemplary embodiments of the disclosed system. Moreover, in the figures, like reference numerals designate corresponding parts through the different views.

FIG. 1 illustrates an interference nulling system in accordance with an exemplary embodiment;

FIG. 2 illustrates a nulling device in accordance with an exemplary embodiment; and

FIG. 3 illustrates a graph of the dimensions of a nulling device based on a distance from the radar system in accordance with an exemplary embodiment.

### DETAILED DESCRIPTION

The system for producing a null region, which can be viewed as an electromagnetic (EM) shadow, between an electromagnetic source and a target will now be described by reference to the accompanying drawings in which like elements are described with like figure numbers. It should be noted that the claimed invention is not limited to these particular embodiments but rather fully encompasses variations and modifications, which may occur to those skilled in the art.

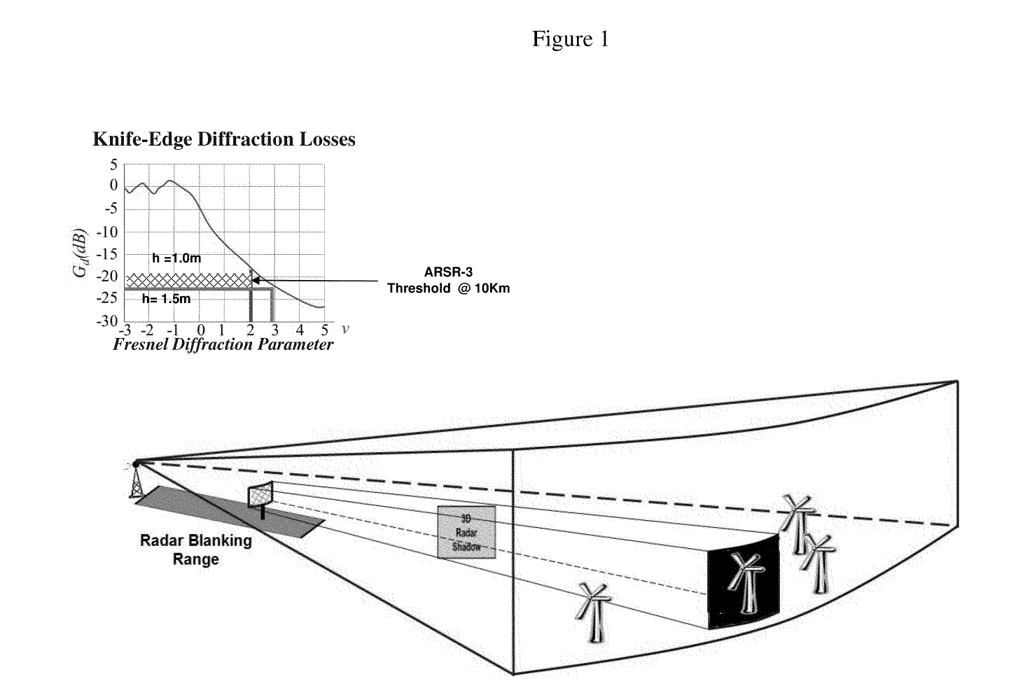

FIG. 1 illustrates an interference nulling system in accordance with an exemplary embodiment. The system described herein includes a radio frequency (RF) precision nulling device (RPND) that utilizes the optical theory of electromagnetic propagation to produce an electromagnetic shadow between an electromagnetic source, and a target. The electromagnetic source can be any system or device for transmitting and detecting electromagnetic radiation, such as a radar system that transmits radar signals and receives return signals reflected from a target, whether the transmitter and receiver are co-located or not. The target can be any object that generates electromagnetic interference, clutter, or an otherwise undesired return signal in a radar system.

The exemplary nulling device can be configured to use a combination of obstructive and destructive interference techniques of diffraction theory, and in particular Fresnel-Zone Diffraction Theory, which has the potential to establish a precisely-structured three-dimensional (3D) null region, if desired. The null region produced by the nulling device electromagnetically obscures a target at a specified distance. For example, using the obstructive and destructive properties, the nulling device diffracts (e.g., blocks) and cancels the transmitted radar signals, thereby preventing radar waves from illuminating or reaching the target.

As shown in FIG. 1, the nulling device can be strategically sited between the radar system and the target so that two conditions are satisfied. The first condition specifies that the nulling device is located in a line-of-sight between a radiating source of the radar system and the target. The second condition specifies that the nulling device be located at a sufficient distance from the radar system receiver so that the receiver will not have to process any or a tolerable amount of return signals from the nulling device. That is, to satisfy the second condition the nulling device might be located in a blanking range of the radar system. For instance, the inset graph of FIG. 1 shows that for a knife edge (e.g., height (h)) of the nulling device in a range of 1.0 m to 1.5 m and below a distance of 10 km, the diffraction loss is approximately 20 dB.

In accordance with an exemplary embodiment, the nulling device can include one or more metal plates, such as aluminum or any other suitable material as desired. The metal plate can be covered in radar-absorbing material to obtain a specified level of attenuation as desired. For example, the metal plate may be covered with X-hand radar absorbing material which can provide approximately 20 dB attenuation of the incident radar signals. The height and width of the metal plate can be determined by a geometry of the target and/or a geometry of the site at which the nulling device is located. This determination is based on a specified or desired effective attenuation of a main beam radiated by the radar system. The metal plate should be large enough to completely block the optical line-of-sight between the radar system and the target.

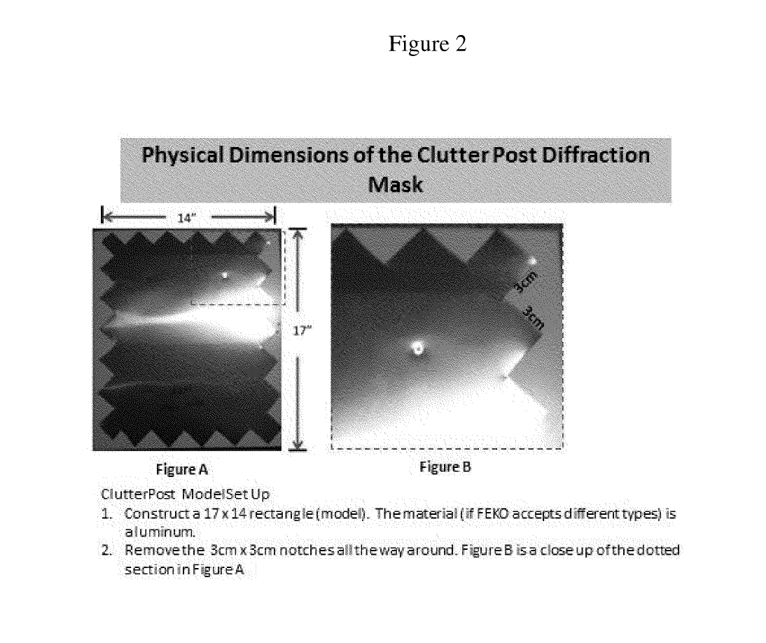

FIG. 2 illustrates a nulling device in accordance with an exemplary embodiment. Under diffraction theory, an obstacle in the path of an electromagnetic wave will produce diffraction at its edges and therefore provide a separate path for the wave to propagate around the obstacle. To prevent the diffracted radar signals from reaching the target, the nulling device can include precision geometric-notching on each outer edge. The notches cause an electromagnetic wave diffracted from the target side of the nulling device to destructively interfere with itself, thereby canceling the electromagnetic waves as it diffracts around the plate. The diffractive-cancellation creates a three-dimensional null region extending from a target-side of the plate to the target. Because the null region envelopes the target, no or a tolerable low amount of radar signals reach the target or are reflected by the plate. Therefore, little or no radar energy is returned to the radar system. How much returned EM energy can be tolerated depends on the particular equipment, siting and purpose or use of the radar.

As shown in FIG. 2, an exemplary nulling device can include edge-serrations that reduce diffraction and effectively mitigate or eliminate an electromagnetic pathway of radar signals diffracted from a radar system-side of the nulling device. Using a corrugation length less than the wavelength of the radar can significantly attenuate the edge diffraction causing the device to operate optically, as if an optical blockage is placed between the radar and the target. The complete blockage of radar signals that are incident on a radar system side of the nulling device realizes an attenuation of the signals or EM shadow on the target-side of the plate. This attenuation prevents a significant amount if not all of the transmitted radar signals from reaching the target and establishes the 3D null region on a target-side of the nulling device.

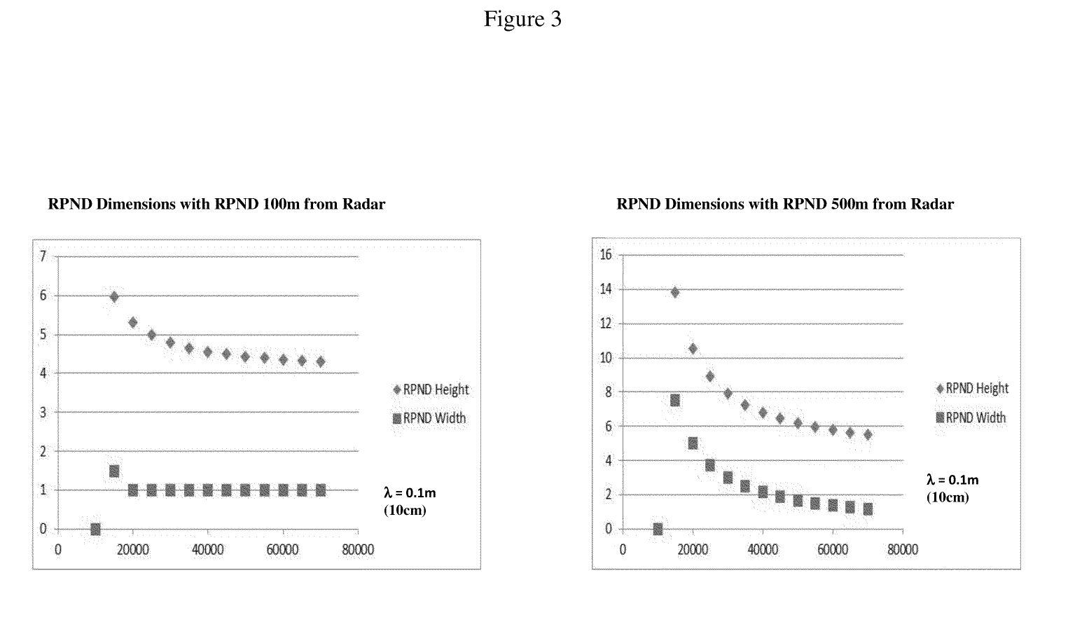

FIG. 3 illustrates a graph of the dimensions of a nulling device based on a distance from the radar system in accordance with an exemplary embodiment. In an exemplary embodiment, the dimensions (e.g., length and width) of the metal plate of the nulling device should be selected such that at least ten wavelengths can be blocked along the length (e.g., height) and width of a specified distance from the electromagnetic source of the radar system. For example, a 14″×17″ metal plate can in effect essentially completely block an X-band radar signal at a 15 meter siting range from the radar source. As shown in FIG. 3, the dimensions of exemplary nulling devices sited at 100 m and 500 m from the radar system, are inversely proportional to the distance. That is, as the sited distance from the radar system increases, the length (e.g., height) and width of the nulling device decrease.

In another exemplary embodiment, the singular nulling device concept can be expanded to include an array of nulling devices or a system of nulling devices that incorporates the precision-nulling properties exhibited by the singular nulling device. A system of nulling devices can be used to selectively eliminate radar returns from a plurality of distant targets, such as a plurality of wind-turbines simultaneously.

In addition to the static placement of a nulling device as described above, other exemplary embodiments include a nulling device or system of nulling devices for creating 3D EM (e.g., RF) null regions between objects and/or EM sources that are in motion, and in environments requiring temporary EM obscuration. For example, a single nulling device can be attached to a vehicle or other moving object so that at any moment it generates the location of the nulling device satisfies the two conditions for establishing the null region. In addition, an exemplary system of nulling devices can be strategically disposed between a radar system and target, where either of the radar system and target can be in motion. The siting of the system of nulling devices can be arranged such that at point in time of operation of the radar system, at least one of the nulling devices in the system can generate a null region with respect to an associated target.

Exemplary nulling devices as disclosed herein, can be stand-alone devices and/or systems that are external to the radar system, and can advantageously produced at low-cost when compared to known designs, which specify modifications the hardware and/or software of the radar system.

Though not necessarily a benefit of all embodiments, compared to conventional mitigation techniques, the present nulling system can selectively blank only Line-of-Sight (LOS) returns, whereas other techniques can eliminate radar returns from all resolution cells with the same range-azimuth as a wind-turbine, for instance, thereby creating potential blind spots in useful airspace. Further, the nulling system allows full-use of navigable airspace, can be set up to affect only unimportant, low-altitude/clutter returns, is comparatively easy to develop and quick to install, does not require modification of radar or wind-turbine systems or site restrictions, is dependable, low cost and scalable.

While the invention has been described with reference to specific embodiments, this description is merely representative of the invention and not to be construed as limiting the invention. Various modifications and applications may occur to those skilled in the art without departing from the true spirit and scope of the invention as defined by the appended claims. For instance, the exemplary embodiment is a radar system, but other EM based systems could benefit from this technology, such as protecting an RF antenna from a particular RF noise source.

What is claimed is:

1. An interference nulling system, comprising:
an electromagnetic (EM) system for transmitting EM signals and receiving return signals reflected from a target; and
a nulling device having a surface for diffracting/blocking the transmitted EM signals to electromagnetically obscure the target, wherein the nulling device is sited between the transmitter and the target in a blanking range of the EM system.

2. The system of claim 1, wherein the the EM system is a radar system.

3. The system of claim 1, wherein the nulling device has height and width determined by a geometry of at least one of the target and the site.

4. The system of claim 1, wherein the nulling device is sited in an optical line-of-sight between the radar system and the target.

5. The system of claim 1, wherein the nulling device includes plural separated metal plates covered in radar-absorbing material.

6. The system of claim 1, wherein each edge of the nulling device is notched to cancel the signals diffracted from the surface of the nulling device.

7. The system of claim 6, wherein a dimension of each notch is determined by at least one of the geometry of the target and the site.

8. A nulling device having a surface for diffracting/blocking the transmitted radar signals to electromagnetically obscure the target, wherein the nulling device is designed to be sited between an electromagnetic transmitter and a target.

9. The nulling device of claim 8, wherein the nulling device has height and width determined by a geometry of at least one of the target and the site.

10. The nulling device of claim 8, wherein the nulling device is sited in an optical line-of-sight between the electromagnetic transmitter and the target.

11. The nulling device of claim 8, wherein the nulling device includes plural separated metal plates covered in electromagnetic wave-absorbing material.

12. The nulling device of claim 8, wherein each edge of the nulling device is notched to cancel the signals diffracted from the surface of the nulling device.

13. The nulling device of claim 8, wherein a dimension of each notch is determined by at least one of the geometry of the target and the site.

14. The nulling device of claim 8, wherein the electromagnetic transmitter is a radar transmitter.
